(19) United States
(12) Patent Application Publication
(10) Pub. No.: US 2025/0253982 A1
(43) Pub. Date: Aug. 7, 2025

(54) SYSTEMS, METHODS, AND DEVICES FOR ARBITRATED AUTOMATIC REPEAT REQUEST (ARQ)

(71) Applicant: Apple Inc., Cupertino, CA (US)

(72) Inventors: Neha GOEL, Oceanside, CA (US); Srinivasan BALASUBRAMANIAN, San Diego, CA (US)

(21) Appl. No.: 18/434,725

(22) Filed: Feb. 6, 2024

(51) Int. Cl. H04L 1/1825; H04L 1/08

(52) U.S. Cl. CPC H04L 1/1825; H04L 1/08

(57) ABSTRACT

Solutions for arbitrated automatic repeat request (ARQ) are described. An arbitrated ARQ may include a transmission repeating technique, such as a data convergence protocol (PDCP) duplication and/or physical uplink shared channel (PUSCH) repetition, that may be implemented based on one or more factors or conditions. Examples of such factors or conditions may include different available transmission (Tx) chains and associated radio conditions, user equipment (UE) capabilities, and flow control latency. Additional examples may include a latency enabler supported in carrier aggregation (CA) or dual connectivity (DC) configurations and/or an exponentially weighted moving average of neighbor cell measurements. The transmission repeating technique may include UE implementing PDCP duplication, PUSCH repetition, both PDCP duplication and PUSCH repetition, or neither of PDCP duplication and PUSCH repetition.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fourth generation (4G), fifth generation (5G) or new radio (NR) technology. Such technology may include solutions for enabling user equipment (UE) and network devices, such as base stations, to communicate with one another. Some scenarios may involve enabling or configuring a UE and/or base station to repeat the transmission of information.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example of an example overview of according to one or more implementations described herein.

FIG. 2 is a diagram of an example network according to one or more implementations described herein.

FIG. 3 is a diagram of an example of a master cell group (MCG) and a secondary cell group (SCG) according to one or more implementations described herein.

FIG. 4 is a diagram of an example of user plane protocol stacks in accordance with one or more implementations described herein.

FIG. 5 is a diagram of an example process for arbitrated automatic repeat request (ARQ) according to one or more implementations described herein.

FIG. 6 is a diagram of an example table for arbitrating ARQ based on signal strength/quality according to one or more implementations described herein.

FIG. 7 is a diagram of an example table for arbitrating ARQ based on support for one or more 3rd Generation Partnership Program (3GPP) Releases according to one or more implementations described herein.

FIG. 8 is a diagram of an example table for arbitrating ARQ based on a flow control latency of an Xn communication interface according to one or more implementations described herein.

FIG. 9 is a diagram of an example table for arbitrating ARQ based on one or more latency enablers according to one or more implementations described herein.

FIG. 10 is a diagram of an example of software instructions for arbitrating ARQ based one or more exponentially weighted moving averages of neighbor cell measurements according to one or more implementations described herein.

FIGS. 11-12 are diagrams of an example process for arbitrated ARQ according to one or more implementations described herein.

FIGS. 13-14 are diagrams of an example process for arbitrated ARQ according to one or more implementations described herein.

FIG. 15 is a diagram of an example of components of a device according to one or more implementations described herein.

FIG. 16 is a block diagram illustrating components, according to one or more implementations described herein, able to read instructions from a machine-readable or computer-readable medium (e.g., a non-transitory machine-readable storage medium) and perform any one or more of the methodologies discussed herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include improving the quality and reliability of signal transmissions by enabling the repeated transmission of information that was not successfully received. In some scenarios, sending repeated transmissions may be performed via packet data convergence protocol (PDCP) duplication and/or physical uplink shared channel (PUSCH) repetition.

PDCP may be implemented as a layer in a protocol stack used to enable communications between a UE and a base station. The PDCP layer may be located within a protocol stack for a control plane, at a position that is below a radio resource control (RRC) layer and above a radio link control (RLC) layer. In a user plane protocol stack, the PDC layer may be located below a Service Data Adaptation Protocol (SDAP) layer and a radio link control (RLC) layer. The PDCP layer may provide services to upper layers of a protocol stack. Examples of such services may include the transfer of user plane data and control plane data; header compression and decompression (e.g., via robust header compression (ROHC); ciphering and deciphering user and control plane data; and integrity protection. The PDCY layer may take services from lower layers of a protocol stack. Examples of such services may include acknowledgement and unacknowledgement of data transfer service.

PDCP duplication may allow for the transmission of the same data packet via multiple RLC/media access control (MAC) instances. PDCP duplication may rely on the duplicate transmissions to occur on orthogonal radio frequency (RF) fading channels. Additionally, based on channel allocation, duplicate transmissions may face correlated fading across the transmissions. Carrier aggregation (CA) and dual connectivity (DC) may be deactivated during weak coverage scenarios so that resources may not be wasted for UEs that are a long distance from one or more cells (e.g., for UEs unable to engage in PDCP duplication).

CA may enable a UE to simultaneously transmit and receive data on multiple component carriers from a single base station. DC may enable a UE to simultaneously transmit and receive data on multiple component carriers from multiple base stations (e.g., a master base station and a secondary base station connected via a non-ideal back-haul over an X2 interface). CA and DC may not be mutually exclusive. They may be jointly implemented for the same UE when, for example, there are multiple carriers in a master cell group (MCG) and multiple carriers in a secondary cell (SCG).

In some scenarios, packet duplication may not be beneficial. For example, the packet lifetime associated with a bearer for a given flow may incur increased delay and may avoid air-link when unnecessary. Also, enabling PDCP duplication may decrease or limit a device's achieved throughput. In some scenarios, PDCP duplication may be controlled through signaling configuration and may therefore be difficult to adapt dynamically to changes in channel conditions for a UE. Additionally, flow control latency with DC is high, reliability may come with a costly latency tradeoff. In such scenarios, DC may be characterized by a non-ideal backhaul connection between a master base station (MeNB or MgNB) and a secondary base station (SeNB or SgNB), and packet duplication may not provide an overall benefit, in terms of latency reduction, when a latency of an Xn communication interface is too high. Additionally, packets sent via an SeNB/SgNB may arrive late at the receiver, such that a retransmission from the MeNB/MgNB might be faster.

In some scenarios, PDCP duplication may not work well when low latency is supported only on one leg of a communication scenario (e.g., such as Configured grants (CG)). Certain carriers/infra may have repetitions supported for dynamic grants (DGs) but not CGs. Additionally, CG may be configured with a robust modulation and coding scheme (MCS) and therefore may not require repetitions. A CG may include a mechanism by which a base station may schedule a physical downlink shared channel (PDSCH) and/or PUSCH without using configuration information (e.g., downlink (DL) control information (DCI) for every transmission. A DG may include a mechanism by which a base station may use configuration information to dynamically schedule PDSCH/PUSCH resources.

PUSCH repetition may increase communication reliability by involving the transmission of redundant versions of information, back-to-back, with each hybrid automatic repeat request (HARQ) transmission. PUSCH repetition may allow for up to 8 repetitions and may be dynamically controlled by a base station via an uplink (UL) scheduler. The repetitions may be done on the same channel and the redundancy version (RV) copies may encounter the same fast-fade scenarios. PUSCH repetition may waste channel capacity, dropping both UE and network throughput/capacity, although the amount wasted may be minimal compared to PDCP duplication.

PUSCH repetition may include type A and type B PUSCH repetition. For type A, data transmission may span multiple slots. For example, a UE may transmit the same transport block (TB) across a pre-configured number of consecutive slots. The same HARQ process may be used for each transmission that is part of the same bundle, and HARQ retransmission may be triggered without waiting from feedback from a previous transmission. For type B, a time gap may be eliminated among repetitions by carrying out repetitions in consecutive mini slots. Type B may also optimize latency with repetition. RVs in PUSCH repetitions may be configured via CG and/or DG. For a DG scenario, RVs may be applied on an Nth occasion, which may be determined according to a communication standard, such at the 3GPP communication standards. For a CG scenario, an information element (IE) or parameter (e.g., a repK-RV parameter) may be used to derive a redundancy version pattern to be applied to the repetitions.

Accordingly, communication reliability in a telecommunication network may be improved by repeated transmissions via PDCP duplication and/or PUSCH repetition. Additionally, PDCP duplication may be preferrable in some scenarios or conditions while PUSCH repetition may be preferrable in others. However, currently available technologies fail to provide any, or adequate, solutions for using PDCP duplication and/or PUSCH repetition based on the conditions within a network. One or more of the techniques described herein may address these deficiencies by providing solutions for enabling and disabling PDCP duplication, PUSCH repetition, and/or a combination of PDCP duplication and PUSCH repetition depending on real-time channel conditions.

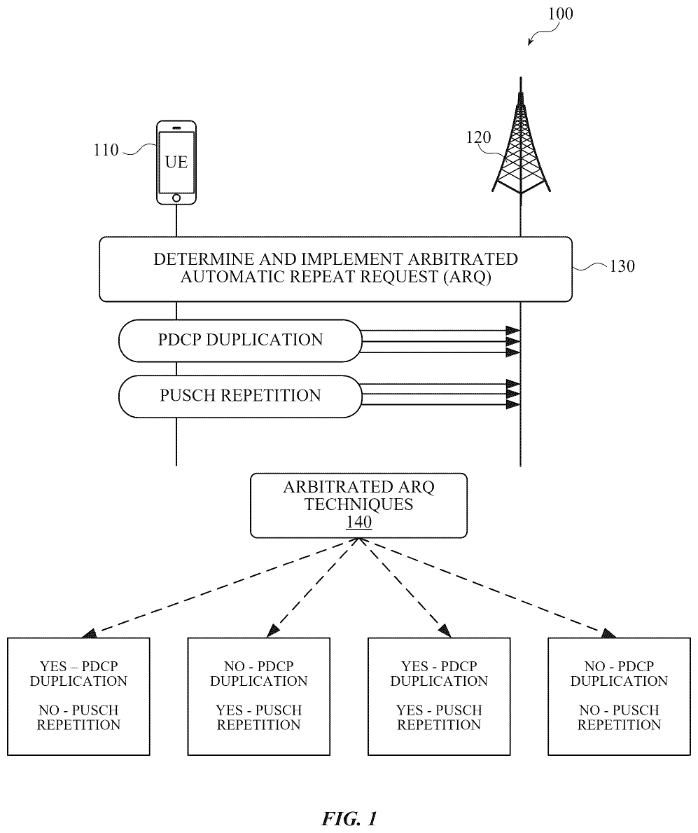

FIG. 1 is a diagram of an example of an overview 100 according to one or more implementations described herein. As shown, overview 100 may include UE 110 and base station 120 determining and implementing an arbitrated ARQ (block 130). An arbitrated ARQ 140, as described herein, may include a transmission repeating strategy or technique, such as PDCP duplication and/or PUSCH repetition, that may be implemented based on one or more factors or conditions. Examples of such factors or conditions may include different available transmission (Tx) chains and associated radio conditions; UE capability information (e.g., whether one or more 3GPP releases are supported by UE 110; and flow control latency between base stations serving UE 110 (e.g., a latency involving an Xn interface). Additional examples may include latency enabler supported in CA/DC configurations and/or an exponentially weighted moving average of neighbor cell measurements. The transmission repeating technique may include implementing PDCP duplication, PUSCH repetition, both PDCP duplication and PUSCH repetition, or none of PDCP duplication and PUSCH repetition. For example, when a slope degree or percentage of an exponentially weighted moving average of neighbor cell measurements is higher than a configurable threshold, both PDCP duplication and PUSCH repletion may be enabled.

In some implementations, the arbitrated ARQ as describe herein may include, or be applied to, transmission repeating techniques for other protocol layers. Examples of this may include application layer repetitions, transmission control protocol (TCP) repetitions, quick user data protocol (UDP) internet connections (QUIC) transport protocol repetitions, and internet protocol (IP) packet repetitions across radio links. In some implementations, different arbitrated ARQ techniques may be applied to different types of data. For example, one ARQ technique may be applied to control information and another ARQ technique may be applied to user data. In another example, an ARQ technique may only be applied to control information or user data. In other examples, different ARQ techniques may be applied to packets of different sizes, ARQ techniques may only be applied to packets exceeding a packet size threshold, etc.

Accordingly, one or more of the techniques described herein may enable arbitrated ARQ. Implementing one or more of these techniques may enhance the degree of coverage provided by the network to UEs and improve the reliability of service at a cell edge and in fast fade scenarios (e.g., when a connection between the network and UE is degrading rapidly). Additional details and examples of these techniques, and others, are discussed below with reference to the following Figures.

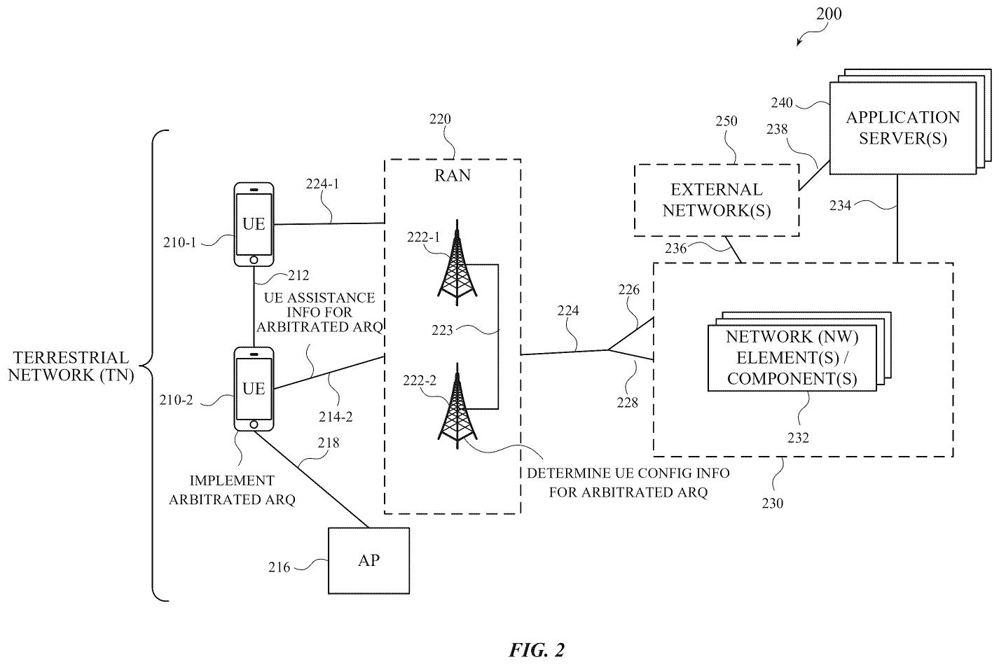

FIG. 2 is an example network 200 according to one or more implementations described herein. Example network 200 may include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 may include smartphones (e.g., handheld touchscreen mobile computing devices connectable to one or more wireless communication networks). Additionally, or alternatively, UEs 210 may include other types of mobile or non-mobile computing devices capable of wireless communications, such as personal data assistants (PDAs), pagers, laptop computers, desktop computers, wireless handsets, etc. In some implementations, UEs 210 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 210 may communicate and establish a connection with one or more other UEs 210 via one or more wireless channels 212, each of which may comprise a physical communications interface/layer. The connection may include an M2M connection, MTC connection, D2D connection, SL connection, etc. The connection may involve a PC5 interface. In some implementations, UEs 210 may be configured to discover one another, negotiate wireless resources between one another, and establish connections between one another, without intervention or communications involving RAN node 222 or another type of network node. In some implementations, discovery, authentication, resource negotiation, registration, etc., may involve communications with RAN node 222 or another type of network node.

UEs 210 may use one or more wireless channels 212 to communicate with one another. As described herein, UE 210 may communicate with RAN node 222 to request SL resources. RAN node 222 may respond to the request by providing UE 210 with a dynamic grant (DG) or configured grant (CG) regarding SL resources. A DG may involve a grant based on a grant request from UE 210. A CG may involve a resource grant without a grant request and may be based on a type of service being provided (e.g., services that have strict timing or latency requirements). UE 210 may perform a clear channel assessment (CCA) procedure based on the DG or CG, select SL resources based on the CCA procedure and the DG or CG; and communicate with another UE 210 based on the SL resources. The UE 210 may communicate with RAN node 222 using a licensed frequency band and communicate with the other UE 210 using an unlicensed frequency band.

UEs 210 may communicate and establish a connection with (e.g., be communicatively coupled) with RAN 220, which may involve one or more wireless channels 214-1 and 214-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 222-1 and 222-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 230. Additionally, at least one of the MN or the SN may be operated with shared spectrum channel access, and functions specified for UE 210 can be used for an integrated access and backhaul mobile termination (IAB-MT). Similar for UE 210, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 222.

As described herein, UE 210 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 210 may also, or alternatively, connect to access point (AP) 216 via connection interface 218, which may include an air interface enabling UE 210 to communicatively couple with AP 216. AP 216 may comprise a wireless local area network (WLAN), WLAN node, WLAN termination point, etc. The connection 216 may comprise a local wireless connection, such as a connection consistent with any IEEE 702.11 protocol, and AP 216 may comprise a wireless fidelity (Wi-Fi®) router or other AP. While not explicitly depicted in FIG. 2, AP 216 may be connected to another network (e.g., the Internet) without connecting to RAN 220 or CN 230. In some scenarios, UE 210, RAN 220, and AP 216 may be configured to utilize LTE-WLAN aggregation (LWA) techniques or LTE WLAN radio level integration with IPsec tunnel (LWIP) techniques. LWA may involve UE 210 in RRC_CONNECTED being configured by RAN 220 to utilize radio resources of LTE and WLAN. LWIP may involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling may include encapsulating the entirety of original IP packets and adding a new packet header, thereby protecting the original header of the IP packets.

RAN 220 may include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 may include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 may include a roadside unit (RSU), a transmission reception point (TRxP or TRP), and one or more other types of ground stations (e.g., terrestrial access points). In some scenarios, RAN node 222 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 222; a media access control (MAC)/physical (PHY) layer split wherein RRC, PDCP, radio link control (RLC), and MAC layers may be operated by the CRAN/vBBUP and the PHY layer may be operated by individual RAN nodes 222; or a “lower PHY” split wherein RRC, PDCP, RLC, MAC layers and upper portions of the PHY layer may be operated by the CRAN/vBBUP and lower portions of the PHY layer may be operated by individual RAN nodes 222. This virtualized framework may allow freed-up processor cores of RAN nodes 222 to perform or execute other virtualized applications.

In some implementations, an individual RAN node 222 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 220 or by a server pool (e.g., a group of servers configured to share resources) in a similar manner as the CRAN/vBBUP. Additionally, or alternatively, one or more of RAN nodes 222 may be next generation eNBs (i.e., gNBs) that may provide evolved universal terrestrial radio access (E-UTRA) user plane and control plane protocol terminations toward UEs 210, and that may be connected to a 5G core network (5GC) 230 via an NG interface.

Any of the RAN nodes 222 may terminate an air interface protocol and may be the first point of contact for UEs 210. In some implementations, any of the RAN nodes 222 may fulfill various logical functions for the RAN 220 including, but not limited to, radio network controller (RNC) functions such as radio bearer management, uplink and downlink dynamic radio resource management and data packet scheduling, and mobility management. UEs 210 may be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 222 to UEs 210, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 222 may be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

The PDSCH may carry user data and higher layer signaling to UEs 210. The physical downlink control channel (PDCCH) may carry information about the transport format and resource allocations related to the PDSCH channel, among other things. The PDCCH may also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) may be performed at any of the RAN nodes 222 based on channel quality information fed back from any of UEs 210. The downlink resource assignment information may be sent on the PDCCH used for (e.g., assigned to) each of UEs 210.

One or more of the techniques, described herein, may enable UE 210 and base station 222 to engage arbitrated ARQ. This may include implementing a transmission repeating technique, such as a PDCP duplication and/or PUSCH repetition, which may be implemented based on one or more factors or conditions. Examples of such factors or conditions may include different available Tx chains and associated radio conditions; UE capabilities, and flow control latency. Additional examples may include a latency enabler supported in CA/DC configurations and/or an exponentially weighted moving average of neighbor cell measurements. The transmission repeating technique may include UE 210 implementing PDCP duplication only, PUSCH repetition only, both PDCP duplication and PUSCH repetition, or neither of PDCP duplication and PUSCH repetition.

The RAN nodes 222 may be configured to communicate with one another via interface 223. In implementations where the system is an LTE system, interface 223 may be an X2 interface. In NR systems, interface 223 may be an Xn interface. The X2 interface may be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 220 may be connected (e.g., communicatively coupled) to CN 230. CN 230 may comprise a plurality of network elements 232, which are configured to offer various data and telecommunications services to customers/subscribers (e.g., users of UEs 210) who are connected to the CN 230 via the RAN 220. In some implementations, CN 230 may include an evolved packet core (EPC), a 5G CN, and/or one or more additional or alternative types of CNs. The components of the CN 230 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 230 may be referred to as a network slice, and a logical instantiation of a portion of the CN 230 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 230, application servers 240, and external networks 250 may be connected to one another via interfaces 234, 236, and 238, which may include IP network interfaces. Application servers 240 may include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 may also, or alternatively, be configured to support one or more communication services (e.g., voice over IP (VOIP sessions, push-to-talk (PTT) sessions, group communication sessions, social networking services, etc.) for UEs 210 via the CN 230. Similarly, external networks 250 may include one or more of a variety of networks, including the Internet, thereby providing the mobile communication network and UEs 210 of the network access to a variety of additional services, information, interconnectivity, and other network features.

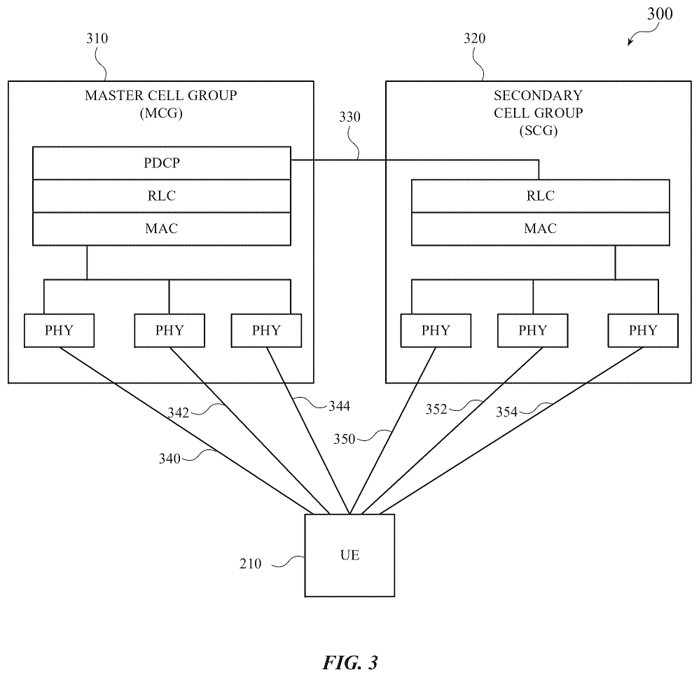

FIG. 3 is a diagram of an example 300 of a master cell group (MCG) 310 and a secondary cell group (SCG) 320 according to one or more implementations described herein. An MCG may include a group of cells associated with a master node, comprising a PCell and one or more SCells. An SCG may include a group of serving cells associated with a secondary node, comprising a primary cell of the secondary cell group (PSCell) and optionally one or more SCells. MCG 310 and SCG 320 may each be implemented by one or more base station 222 and/or another type of RAN node or access point.

MCG 310 may be implemented by one or more base stations and may include one or more layers. Examples of such layers may include a PDCP layer, an RLC layer, a MAC layer, and multiple PHY layers. Each PHY layer may correspond to a different implementation of a cell with respect to UE 210. Additionally, or alternatively, the PHY layers may operate in combination (e.g., be managed, controlled by, etc.) the PDCP, RLC, and MAC layers. In some implementations, one PHY layer 340 may operate as a PCell or a special cell (SpCell) and other PHY layers 342 and 344 may operate as SCells to the PCell.

SCG 320 may include multiple layers as well, including an RLC layer, a MAC layer, and multiple PHY layers 350, 352, and 354. SCG 320 may not include a PDCP layer, but instead may rely on the PDCP layer of MCG 310 via connection 330. Similar to the PHY layers of MCG 310, the PHY layers of SCG 320 may each function or operate as a cell with respect to UE 210. In some implementations, one PHY layer 350 may operate as a primary cell (PCell) to PHY layers 352 and 354, which may operate as secondary cells to the PCell of PHY layer 350. Additionally, MCG 310 and SCG 320 may each include a PCell (e.g., 340 and 350), and a PCell may be referred to herein as a special cell or special primary cell, represented as SpCell. Further, a SCell, of either MCG 310 or SCG 320, may operate as a scheduling secondary cell (sSCell) configured to provide configuration, scheduling, activation, deactivation, and other functions or commands toward a SpCell of either MCG 310 or SCG 320.

MCG 310 and SCG 320 may be involved in a dual connectivity scenario with UE 210, in which case a random access channel (RACH) procedure, and the like, may be directed to MCG 310. MCG 310 and SCG 320 may also implement a standalone (SA) and/or a non-standalone (NSA) network environment for UE 210. In a SA network environment, MCG 310 and SCG 320 may communicate with UE 210 using 5G NR communication standards. In an NSA network environment, MCG 310 and SCG 320 may communicate with UE 210 using a combination of 4G LTE and 5G NR communication standards. MCG 310 and/or SCG 320 may be configured to enable, support, and/or operate in accordance with the techniques described herein for signaling and procedure for communications via a UL-only TRP. For example, one or more of the techniques described herein may include solutions for scenarios in which a macro cell (e.g., a base station 222 operating as an MCG or PCell with respect to UE 210) causes or enables UL-only communications via another base station 222 that is operating as a SCG or SCell.

One or more of the techniques described herein may be implemented to enable arbitrated ARQ. This may include implementing a transmission repeating technique, such as a PDCP duplication and/or PUSCH repetition, which may be implemented based on one or more factors or conditions. Examples of such factors or conditions may include different available Tx chains and associated radio conditions; UE capabilities, and flow control latency. Additional examples may include a latency enabler supported in CA/DC configurations and/or an exponentially weighted moving average of neighbor cell measurements (e.g., of a PCell, an SCell, MCG 310, and/or SCG 320). The transmission repeating technique may include UE 210 implementing PDCP duplication only, PUSCH repetition only, both PDCP duplication and PUSCH repetition, or neither of PDCP duplication and PUSCH repetition.

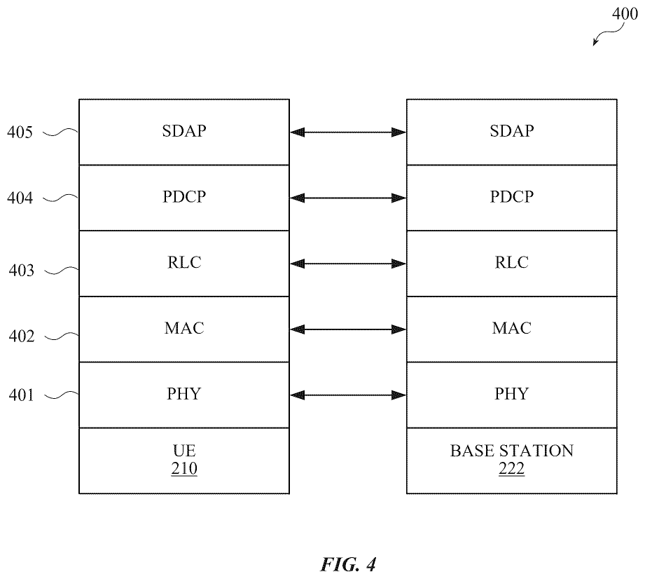

FIG. 4 is a diagram of an example of user plane protocol stacks 400 in accordance with one or more implementations described herein. User plane protocol stacks 400 may be implemented as a communications protocol between communication devices, such as UE 210, base station 222, etc., represented here as transmitter 410 and receiver 420. User plane protocol stacks 400 may include PHY layer 401, MAC layer 402, RLC layer 403, PDCP layer 404, and SDAP layer 405. An instance of a layer may be referred to herein as an entity of the layer. For example, an instance of PDCP layer 404 may be referred to herein as a PDCP entity (not shown), an instance of MAC layer 402 may be referred to as a MAC entity (not shown), and so on. In some implementations, user plane protocol stacks 400 may enable communication by implementing one or more instances of any layer of user plane protocol stacks 400.

PHY layer 401 may transmit or receive information used by MAC layer 402 over one or more air interfaces. PHY layer 401 may further perform link adaptation or adaptive modulation and coding (AMC), power control, cell search (e.g., for initial synchronization and handover purposes), and other measurements used by higher layers, such as the RRC layer of the control plane protocol stack (not shown). PHY layer 401 may still further perform error detection on the transport channels, forward error correction (FEC) coding/decoding of the transport channels, modulation/demodulation of physical channels, interleaving, rate matching, mapping onto physical channels, and multiple input multiple output (MIMO) antenna processing.

MAC layer 402 may perform mapping between logical channels and transport channels, multiplexing of MAC service data units (SDUs) from one or more logical channels onto TB to be delivered to PHY via transport channels, de-multiplexing MAC SDUs to one or more logical channels from transport blocks TBs delivered from the PHY via transport channels, multiplexing MAC SDUs onto TBs, scheduling information reporting, error correction HARQ, and logical channel prioritization.

RLC layer 403 may operate in a plurality of modes of operation, including: transparent mode (TM), unacknowledged mode (UM), and/or acknowledged mode (AM). RLC layer 403 may execute transfer of upper layer protocol data units (PDUs), error correction through ARQ for AM data transfers, and concatenation, segmentation and reassembly of RLC SDUs for UM and AM data transfers. RLC layer 403 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

PDCP layer 404 may execute header compression and decompression of IP data, maintain PDCP sequence numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

When PDCP duplication is not enabled for a PDCP entity, a PDCP packet (e.g., a PDU) may be transmitted by PDCP layer 404 to an RLC entity (e.g., a single instance of RLC layer 403), and the RLC entity may pass corresponding information to MAC layer 402. When PDCP duplication is enabled, a PDCP packet may be transmitted to multiple RLC entities (e.g., a primary instance of RLC layer 403 and a secondary instance of RLC layer 403). In such a scenario, both RLC entities may process the packet independently and transmit the processed packet to MAC layer 402. From the perspective of MAC layer 402, each RLC transmission may be treated as different, independent packets. This may be done to enhance reliability and reduce time delays.

When activation of PDCP duplication is indicated, a transmitting PDCP entity may indicate that PDCP duplication is enabled for corresponding signal radio bearers (SRBs) and/or data radio bearers (DRBs). When deactivation of PDCP duplication is indicated, a transmitting PDCP entity may indicate that PDCP duplication is disabled. Additionally, or alternatively, during PDCP duplication, when confirmation of a successful transmission of a PDU is received by one of two or more RLC entities, PDCP entity may indicate to the other RLC entities to discard the duplicated PDCP data PDU. Additionally, when deactivation of PDCP duplication is indicated, a PDCP entity may indicate to any secondary PDCP entities to discard all duplicated PDCP data PDUs.

Service data adaptation protocol (SDAP) layer 405 may be implemented only in the user plane in both gNB and UE. SDAP layer 405 may interface to upper layers via QoS flows and to the PDCP lower layer via Data Radio Bearers (DRBs). Traffic from QoS flows may be mapped to suitable DRBs. When SDAP receives a PDU from upper layer flow (e.g., TCP/IP), the PDU is associated with QoS for this flow. SDAP layer 405 may map the flow to a DRB. Similarly, when a PDU is received at the PDCP, the PDU may contain an SDAP header which may be removed, and the PDU is passed to upper layer.

UE 210 and base station 222 may utilize a Uu interface (e.g., an NR interface) to exchange control plane data via a protocol stack comprising the PHY layer 401, the MAC layer 402, RLC layer 403, PDCP layer 404, and RRC layer 405. Non-access stratum (NAS) protocols (not shown) may form a stratum of a control plane between the UE and the CN. The NAS protocols may support the mobility of the UE and the session management procedures to establish and maintain IP connectivity between the UE and the network.

A main service and function of RRC layer 405 may include the broadcast of system information (e.g., included in master information blocks (MIBs) or system information blocks (SIBs) related to the NAS, broadcast of system information related to the access stratum (AS), paging, establishment, maintenance and release of an RRC connection (e.g., RRC connection paging, RRC connection establishment, RRC connection modification, and RRC connection release), establishment, configuration, maintenance and release of point to point Radio Bearers, security functions including key management, inter RAT mobility, and measurement configuration for UE measurement reporting. MIBs and SIBs may comprise one or more IEs, which may each comprise individual data fields or data structures.

Arbitrated ARQ, as described herein, may be implemented as a transmission repeating technique configured at one or more protocol layers. For example, PDCP duplication may include the creation of multiple RLC entities and MAC entities for duplicated PDCP flows. This may cause the duplicated PDCP flows to be processed as unique data flows. As another example, PUSCH repetition may include multiple instances of a transmission to be communicated as part of a HARQ procedure, or other type of procedure, performed a MAC entity or an entity of another protocol layer.

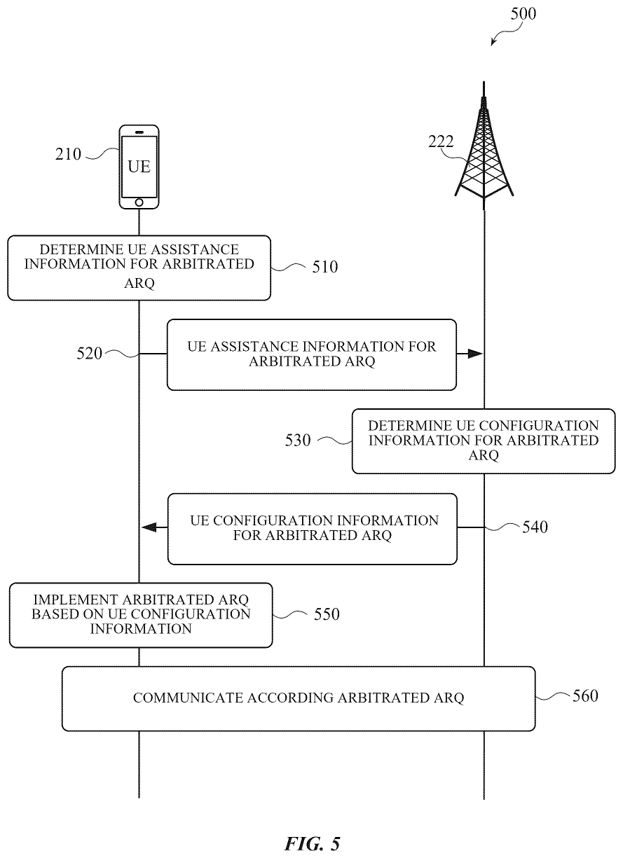

FIG. 5 is a diagram of an example process 500 for arbitrated automatic repeat request (ARQ) according to one or more implementations described herein. Process 500 may be implemented by UE 210 and one or more base stations 222. In some implementations, some or all of process 500 may be performed by one or more other systems or devices, including one or more of the devices of FIG. 2. Additionally, process 500 may include one or more fewer, additional, differently ordered and/or arranged operations than those shown in FIG. 5. Some or all of the operations of process 500 may be performed independently, successively, simultaneously, etc., of one or more of the other operations of process 500. Further, one or more of the operations of process 500 may include one or more of the features, conditions, information, characteristics, etc., described elsewhere herein. As such, the techniques described herein are not limited to the number, sequence, arrangement, timing, type, etc., of the operations or processes depicted in FIG. 5.

As shown, process 500 may include UE 210 determining UE assistance information for arbitrated ARQ (block 510). In some implementations, UE 210 may determine the UE assistance information based on one or more conditions or factors measured, detected, or identified by UE 210. Examples of such conditions or factors may include different available Tx chains and associated radio conditions, whether UE 210 supports one or more 3GPP releases, and/or an Xn flow control latency between base stations 222 communicating with UE 210. Additional, or alternative, examples of such conditions or factors may include whether UE 210 is communicating via CA, whether UE 210 is communicating via DC, and/or one or more latency enablers supported in a CA and/or configuration. A latency enabler, as described herein, may include one or more latency features, such as CGs, semi-persistent scheduling (SPS), etc. Another example of a condition or factor that may be measured, detected, or identified by UE 210 may include an exponentially weighted moving average of neighbor cell measurements. In some implementations, the UE assistance information may be based on one or more capabilities of UE 210, such as the ability of UE to perform PDCP duplication, PUSCH repetition, etc.

Process 500 may include UE 210 communicating UE assistance information for arbitrated ARQ (block 520). The UE assistance information may include an indication of one or more of the conditions or factors described above, such as different available Tx chains and associated radio conditions, whether UE 210 supports one or more 3GPP releases, and/or an Xn flow control latency, a CA/DC configuration of UE 210, and/or an exponentially weighted moving average of neighbor cell measurements. In some implementations, UE may send the UE assistance information in an RRC message that is part of a mechanism for providing base station 222 with one or more types of information about a status or condition of UE 210. In some implementations, the UE assistance information may include UE capability information. In other implementations, the UE assistance information may be different than UE capability information. The UE assistance information may also include an indication of one or more Tx chains, including which conditions or factors correspond to which Tx chains.

Process 500 may include base station 222 determining UE configuration information for arbitrated ARQ (block 530). For example, base station 222 may receive the UE assistance information, and based on the UE assistance information, may determine information that may be used to configure UE 210 for ARQ. The UE configuration information may be selected to configure UE 210 for PDCP duplication, PUSCH repetition, both PDCP duplication and PUSCH repetition, or none of PDCP duplication and PUSCH repetition.

Process 500 may include base station 222 communicating the UE configuration information to UE 210 (block 540). For example, base station 222 may transmit information and/or instructions to UE 210 that are configured to cause or enable UE 210 to implement a transmission repeating technique described herein. This may include information and/or instruction that may cause UE 210 to implement PDCP duplication, PUSCH repetition, both PDCP duplication and PUSCH repetition, or none of PDCP duplication and PUSCH repetition. In some implementations, the UE configuration information may include an indication of one or more Tx chains to which the transmission repeating technique(s) apply.

Process 500 may include UE 210 implementing arbitrated ARQ based on the UE configuration information (block 550). For example, UE 210 may receive UE configuration information from base station 222 and may implement the received configuration. As the UE configuration information may include instructions and/or information for arbitrated ARQ, implementing the UE configuration information may cause UE 210 to enable one or more types of transmission repetition techniques, such as PDCP duplication, PUSCH repetition, both PDCP duplication and PUSCH repetition, or none of PDCP duplication and PUSCH repetition. In some implementations, the UE configuration information may include an indication for UE 210 to discontinue a transmission repetition technique (e.g., PDCP duplication) being performed by UE 210.

Process 500 may include UE 210 communicating with base station 222 according to arbitrated ARQ (block 560). For example, upon receiving the UE configuration information and implementing the UE configuration information, UE 210 may proceed to communicate with base station 222 according to a transmission repetition technique indicated by the UE configuration information. This may include UE 210 implementing PDCP duplication, PUSCH repetition, both PDCP duplication and PUSCH repetition, or none of PDCP duplication and PUSCH repetition.

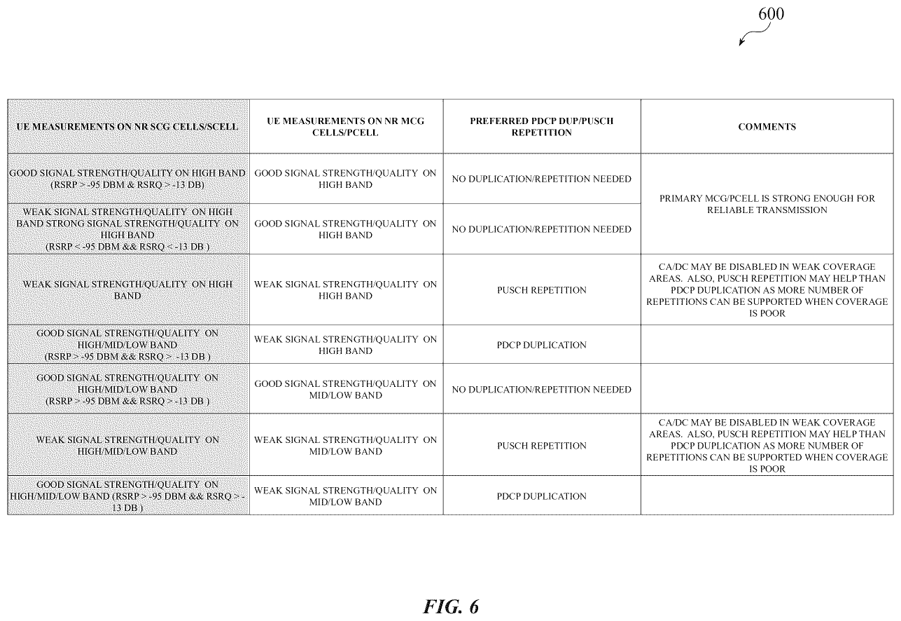

FIG. 6 is a diagram of an example table 600 for arbitrating ARQ based on signal strength/quality according to one or more implementations described herein. As shown, table 600 may include a column for UE measurements of NR SCG cells and/or one or more SCells, UE measurements on NR MCG cells and/or one or more PCells, a preference for PDCP duplication (DUP) and/or PUSCH repetition, and comments. Rows of table 600 may correspond to varying scenarios described by cells of the row and corresponding columns. The information provided in table 600 are non-limiting examples of one or more of the techniques, described herein, for arbitrated ARQ.

As shown, UE measurements (e.g., for an NR SCG cell, SCell, NR MCG cells, and/or a PCell) may pertain to a high band, middle (or mid) band, or low band. A high band may include a frequency band consisting of frequencies of between 24 gigahertz (GHz) and 40 GHz. A middle (or mid) band may include a frequency band consisting of frequencies between 1 GHZ and 6 GHz. A low band may include a frequency band consisting of frequencies of less than 1 GHz. The UE measurement may include a measurement of a reference signal received power (RSRP), a reference signal received quality (RSRQ), signal-to-interference-plus-noise ratio (SINR), and/or another type of signal measurement.

Additionally, a UE measurement may demonstrate that a signal strength and/or quality is good or weak. This may involve a comparison of a measured signal to one or more signal strength and/or quality threshold. For example, a good signal strength or quality on a high band may involve a scenario in which a measured RSRP is greater than-95 decibel-milliwatts (dBm) and a measured RSRQ is greater than-13 decibels (dB). A weak signal strength or poor signal quality may involve a scenario in which a measured RSRP is less than-95 dBm and a measured RSRQ is less than-13 dB. Different implementations may use different types of signal measurements and different decibel thresholds.

In addition to describing UE measurement conditions, table 600 includes responses corresponding to those conditions (e.g., PDCP duplication, PSCH repetition, etc.). Also provided are descriptions or comments about the state or status of the network. For example, some UE measurements may indicate that a signal of an MCG or PCell is strong enough for reliable transmission. As another example, some UE measurements may be consistent with CA and/or DA being disabled, in addition to why PDCP duplication, PSCH repetition, etc., may be helpful.

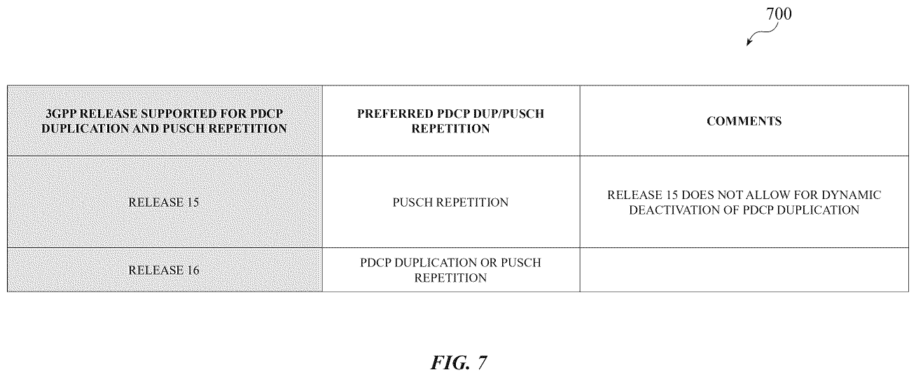

FIG. 7 is a diagram of an example table 700 for arbitrating ARQ based on support for one or more 3GPP Releases according to one or more implementations described herein. As shown, table 700 may include a column for 3GPP Release that may be supported by UE 210 and a column for a transmission repeating technique (e.g., PUSCH repetition and/or PDCP duplication). As shown, when UE 210 supports 3GPP Release 15, UE 210 may support PUSCH repetition but not PDCP duplication. In such scenarios, UE 210 may implement PUSCH repetition and PUSCH repetition may be dynamically enabled and disabled. As shown, in a comment column of table 700, 3GPP Release 15 may not allow for dynamic deactivation of PDCP duplication.

When UE 210 supports 3GPP Release 16, UE 210 may support PUSCH repetition and PDCP duplication. In such scenarios, UE 210 may implement (e.g., may be configured by base station 222) PUSCH repetition only, PDCP duplication only, PUSCH repetition and PDCP duplication, and neither PUSCH repetition nor PDCP duplication. One or more of the techniques described herein may involve the use of one or more additional and/or alternative 3GPP Releases than those shown in FIG. 7. Whether UE 210 supports a particular 3GPP Release may be indicated in system information stored locally by UE 210. UE 210 may also send such information to base station 222 as UE assistance information, UE capability information, and/or another type of information.

For Release 15, PDCP packet duplication may be possible using two independent transmission paths (e.g., cells/carriers) in RAN 220. This may increase reliability and reduce latency. PDCP packet duplication may be supported in CA and DC, and the PDCP layer may provide packet duplicates to two associated RLC logical channels or entities. In DC, these logical channels may belong to different cell groups. In CA, these logical channels may have a transmission restriction, such that transmission is allowed only on different carriers. For Release 16, PDCP packet duplication may occur with up to four copies over up to four logical channels. Additionally, a dynamic network control (e.g., control by base station 222) of PDCP duplication activation/deactivation may be available via MAC command.

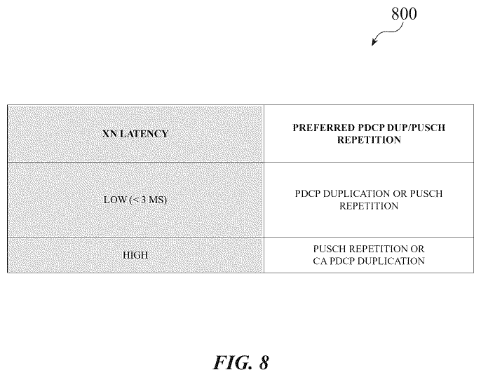

FIG. 8 is a diagram of an example table 800 for arbitrating ARQ based on a flow control latency of an Xn communication interface according to one or more implementations described herein. As shown, table 800 may include a column for an Xn latency and a column indicating a corresponding preference for PDCP duplication and PUSCH repetition. Xn latency may be a measured latency for communications between base stations 222 via an Xn communication interface. When Xn latency is low (e.g., less than 3 milliseconds (ms)), UE 210 may implement PDCP duplication, PUSCH repetition, or both PDCP duplication and PUSCH repetition. When Xn latency is high (e.g., greater than or equal to 3 ms), UE 210 may implement PDCP duplication in a CA scenario or PUSCH repetition. In some implementations, different measurements of latencies (e.g., latencies of different communication interfaces) may be used. Additionally, or alternatively, one or more additional or different latency thresholds may be used.

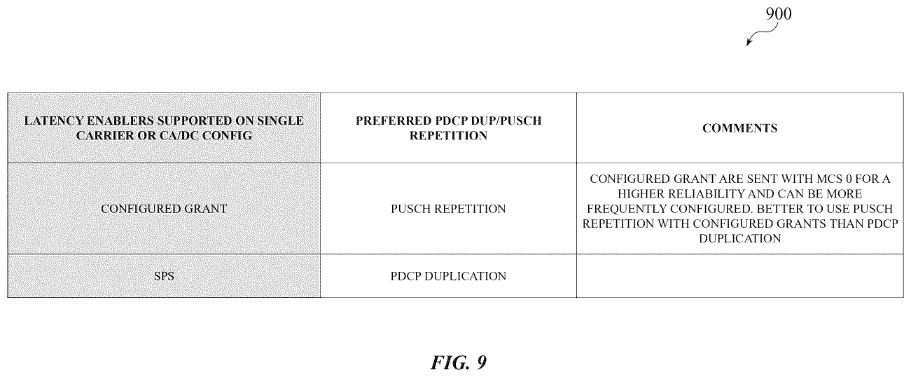

FIG. 9 is a diagram of an example table 900 for arbitrating ARQ based on one or more latency enablers according to one or more implementations described herein. A latency enabler, as described herein, may include one or more latency features, such as CGs, SPS, etc. As shown, table 900 may include a column for scenarios in which latency enablers may be supported in a single carrier scenario or in a CA and/or DC scenario, in addition to a column indicating a corresponding preference for PDCP duplication and PUSCH repetition. A comments column is also provided. In a CG scenario, there may be a preference to cause or enable UE 210 to implement PUSCH repetition. As shown, a CG may be sent with MCS 0 for a higher reliability and/or may be more frequently configured. As such, it may be beneficial to use PUSCH repetition in a CG scenario instead of PDCP duplication. By contrast, in a SPS scenario, there may be a preference to cause or enable UE 210 to implement PDCP duplication. An SPS may involve a scenario in which base station 222 schedules PDSCH resources without using DCI for every transmission. Instead, base station 222 may assign channel resources using RRC signaling.

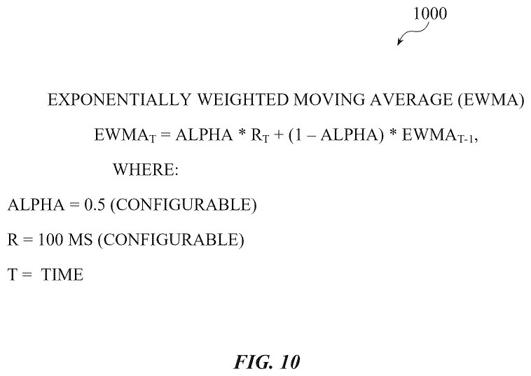

FIG. 10 is a diagram of an example 1000 of software instructions for arbitrating ARQ based one or more exponentially weighted moving averages (EWMA) of neighbor cell measurements according to one or more implementations described herein. Arbitrating ARQ may involve UE 210 evaluating neighbor cell measurements based on an EWMA. As shown, UE 210 may determine EWMA based on the following expression.

EWMA_{T}=alpha*R_{T}+(1−alpha)*EWMA_{T-1}

The value of alpha may be 0.5, the value of R may be 100 ms, and T may be a time corresponding to an iteration of determining EWMA. The value of alpha and R may be configurable, such that values of alpha and r may be indicated by configuration information, determined based on one or more factors or conditions, and/or may vary depending on the scenario. EWMA_{T-1} may be an EWMA value at a time immediately prior to the current EWMA being determined. UE 210 may detect and/or determine a slope, degree, or percentage of an EWMA, and compare the determined EWMA to one or more thresholds. When the slope, degree, or percentage is greater than a corresponding threshold value, both PDCP duplication and PUSCH repetition may be enabled.

The threshold value may be configurable, such that the type of threshold and/or the value of the threshold may vary based on configuration information, one or more factors or conditions, and/or may vary depending on the scenario. In some implementations, UE 210 may use one or more additionally and/or different equations, values, variables, and/or algorithms may be used to determine EWMA of neighbor cell measurements than the example of FIG. 10.

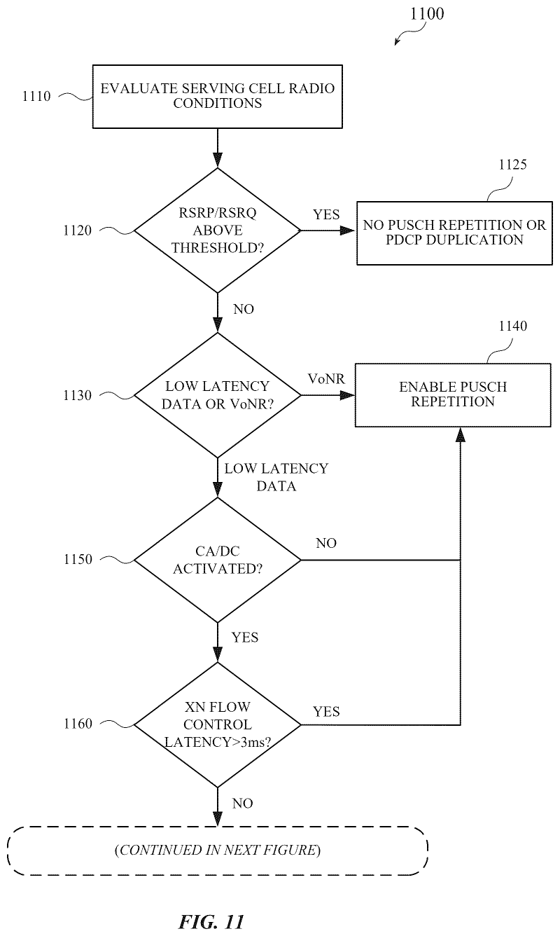

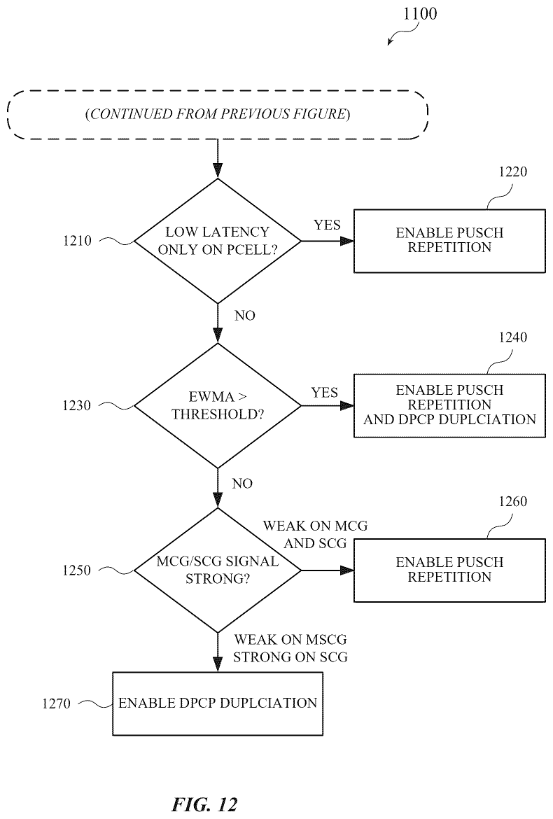

FIGS. 11-12 are diagrams of an example process 1100 for arbitrated ARQ according to one or more implementations described herein. Process 1100 may be implemented by UE 210. In some implementations, some or all of process 1100 may be performed by one or more other systems or devices, including one or more of the devices of FIG. 2. Additionally, process 1100 may include one or more fewer, additional, differently ordered and/or arranged operations than those shown in FIGS. 11-12. Some or all of the operations of process 1100 may be performed independently, successively, simultaneously, etc., of one or more of the other operations of process 1100. Further, one or more of the operations of process 1100 may include one or more of the features, conditions, information, characteristics, etc., described elsewhere herein. As such, the techniques described herein are not limited to the number, sequence, arrangement, timing, type, etc., of the operations or processes depicted in FIGS. 11-12.

As shown, process 1100 may include evaluating serving cell radio conditions (block 1110). For example, UE 210 may monitor or measure one or more conditions or characteristics relating to base station 222. In some implementations, this may include measuring an RSRP, an RSRQ, etc. The measurements may relate to a PCell, SCell, MCG, and/or SCG. Additionally, or alternatively come on the measurements may relate to an CA type scenario or a DC type scenario.

Process 1100 may include determining whether an RSRP and/or RSRQ is above a threshold (block 1120). For example, UE210 may compare the serving cell radio conditions to one or more thresholds comment which may include one or more pre-selected decibel levels. An example of such a threshold may include an RSRP threshold. Another example of such a threshold may include an RSRQ threshold. When the RSRP and/or RSRQ is above a corresponding threshold or set of thresholds (block 1120—Yes), process 1100 may include UE 210 not enabling, or disabling, PUSCH repetition or PDCP duplication (block 1125). When the RSRP and/or RSRQ is above a corresponding threshold or set of thresholds (block 1120—No), process 1100 may include UE 210 determining whether a traffic flow comprises low latency data or a low latency service, or whether the traffic flow comprises a voice-over NR (VoNR) flow or service. A low latency data or a low latency service, as described herein, may include a data flow from UE 210 to base station 222 experiencing a measured latency that is less than a configurable latency threshold. In some implementations, process 1100 may apply to another type of real-time data flow or service (e.g., other than VoNR). When the traffic flow comprises a VoNR (block 1130—VoNR), process 1100 may include UE 210 enabling PUSCH repetition for the traffic flow (block 1140).

When the traffic flow comprises low latency data (block 1130—Low Latency Data), process 1100 may include UE 210 determining whether CA or DC is activated for the traffic flow (block 1150). For example, UE 210 may determine whether the traffic flow, or a service corresponding to the traffic flow, is facilitated by CA or DC with one or more base stations 222. When CA or DC is not activated (block 1150—No), process 1100 may include UE 210 enabling PUSCH repetition for the traffic flow (block 1140). When CA or DC is activated (block 1150—Yes), process 1100 may include UE 210 determining whether a Xn control flow latency is greater than 3 ms (block 11k40). For example, UE 210 may measure a latency corresponding to a control flow of an Xn interface between base stations 222 communicating with UE 210. In some implementations, UE 210 may receive an indication of the Xn control flow latency from one of the base stations 222. When an Xn control flow latency is greater than a latency threshold of 3 ms (block 1160—Yes), process 1100 may include UE 210 enabling PUSCH repetition for the traffic flow (block 1140). When an Xn control flow latency is less than the latency threshold of 3 ms (block 1160—No), process 1100 may include UE 210 determining whether low latency are only configured on a PCell to which UE 210 is connected (block 1210 of FIG. 12). A low latency feature, as described herein, may include a data service, traffic flow, etc., that requires or performs better in low latency conditions (e.g., real-time services and data flows), For example, in response to determining that only traffic flows toward a PCell (as opposed to the PCell and an SCell), UE 210 may enable PUSH repetition. UE 210 may determine whether a latency feature is a low latency feature by determining whether a latency requirement or preference of a traffic flow is less than a latency threshold. In other implementations, UE 210 may determine that a traffic flow is a low latency based on a characteristic of the traffic flow (e.g., a QoS, whether the traffic flow corresponds to a real-time service, a latency requirement or preference of the traffic flow, etc.).

When a low latency feature only applies to the PCell (block 1210—Yes), process 1100 may include UE 210 enabling PUSCH repetition for the traffic flow (block 1220). When a low latency feature does not only apply to the PCell (block 1210—No), process 1100 may include UE 210 determining whether an EWMA is greater than a corresponding threshold for evaluating an EWMA (block 1230). The EWMA may be based on the PCell, SCell, MCG, and/or SCG for which low latency feature are enabled. The threshold to which UE 210 may compare the EWMA may be referred to as an EWMA threshold. When the EWMA is greater than the corresponding threshold (block 1230—Yes), process 1100 may include enabling PUSCH repetition and PDCP duplication (block 1240). When the EWMA is not greater than the corresponding threshold (block 1230—No), process 1100 may include determining whether an MCG signal and/or an SCG signal is strong (block 1250).

Determining whether an MCG signal and an SCG signal is strong may include UE 210 measuring a strength or quality of a signal from MCG and SCG and comparing the measured signal strength or signal quality to a corresponding threshold. UE 210 may determine a signal strength and signal quality for the MCG by measuring an RSRP and RSRQ of the MCG, and by comparing the measured RSRP and RSRQ to corresponding RSRP and RSRQ threshold values. Similarly, UE 210 may determine a signal strength and signal quality for the MCG by measuring an RSRP and RSRQ of the SCG, and by comparing the measured RSRP and RSRQ to corresponding RSRP and RSRQ threshold values. In some implementations, threshold values for an RSRP and RSRQ of the MCG and SCG may be the same. In some implementations, threshold values for an RSRP and RSRQ of the MCG and SCG may be different. When signals of the MCG and SCG are weak (block 1250—Weak on MCG and SCG), process 1100 may include UE 210 enabling PUSCH repetition for the traffic flow (block 1260). When a signal of the MCG is weak and a signal of the SCG is strong (block 1250—Weak on MCG strong on SCG), process 1100 may include UE 210 enabling PDCP duplication for the traffic flow (block 1270).

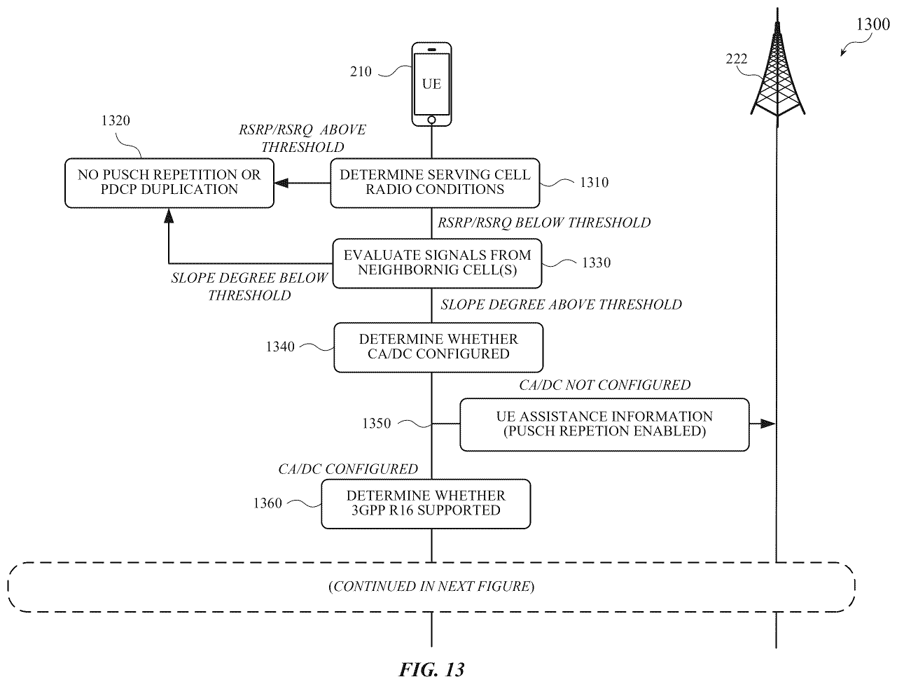

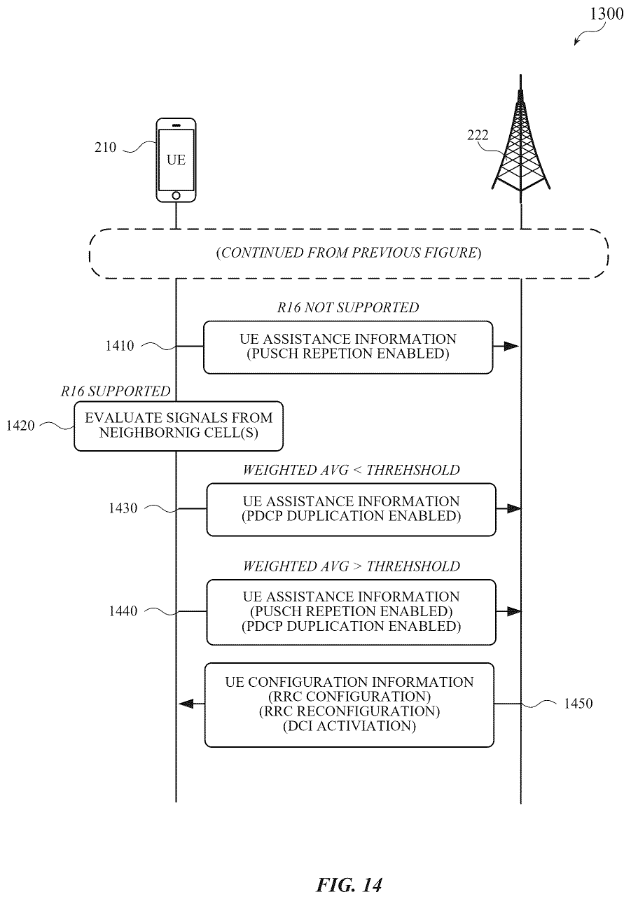

FIGS. 13-14 are diagrams of an example process 1300 for arbitrated ARQ according to one or more implementations described herein. Process 1300 may be implemented by UE 210 and one or more base stations 222. In some implementations, some or all of process 1300 may be performed by one or more other systems or devices, including one or more of the devices of FIG. 2. Additionally, process 1300 may include one or more fewer, additional, differently ordered and/or arranged operations than those shown in FIGS. 13-14. Some or all of the operations of process 1300 may be performed independently, successively, simultaneously, etc., of one or more of the other operations of process 1300. Further, one or more of the operations of process 1300 may include one or more of the features, conditions, information, characteristics, etc., described elsewhere herein. As such, the techniques described herein are not limited to the number, sequence, arrangement, timing, type, etc., of the operations or processes depicted in FIGS. 13-14.

As shown, UE 210 may determine radio conditions of a serving cell (block 1310). For example, UE 210 may perform one or more procedures to evaluate a strength and quality of one or more signals between UE 210 and one or more base stations 222. The base stations 222 may include a PCell, SCell, MCG, and/or SCG serving UE 210. UE 210 may perform a RSRP procedure, RSRQ procedure, SINR procedure, etc., to evaluate the radio conditions. UE 210 may also compare the characteristics (e.g., strength, quality, etc.) of a measured signal to one or more signal thresholds, including a pre-selected RSRP threshold, RSRQ threshold, SINR threshold, etc.

When one or more of a measured RSRP and a measured RSRQ is above a corresponding threshold, UE 210 may proceed by disabling (or not implementing) PUSCH repetition or PDCP duplication for traffic corresponding to the signal measurements (block 1320). By contrast, when one or more of a measured RSRP and a measured RSRQ is above a corresponding threshold, UE 210 may proceed by evaluating measurements of signals from neighboring cells (block 1330). UE 210 may determine an EWMA for measured signals from neighboring cells and may evaluate the measured signals based on the EWMA. This may include determining whether a detected slope degree or percentage of the EWMA is higher than a corresponding threshold (also referred to herein as an EWMA threshold). The threshold may be configured.

When the slope degree or percentage is below the threshold, UE 210 may proceed by disabling (or not implementing) PUSCH repetition or PDCP duplication for traffic corresponding to the signal measurements (block 1320). When the slop degree or percentage is above the threshold, UE 210 may proceed by determining whether CA and/or DC is configured (block 1340). This may include determining whether UE 210 is currently communicating with one or more serving cells using CA or DC. In some implementations, this may also, or alternatively, include determining whether UE 210 is capable of communicating with one or more serving cells using CA or DC.

When CA and/or DC is not configured, UE 210 may generate and communicate UE assistance information to base station 222 (block 1350). UE 210 may also enable (or forego disabling) PUSCH repetition and disable (or forego enabling) PDCP duplication. In some implementations, the UE assistance information may include a coverage assistance value (e.g., a 1-bit value), a field, an IE, or an RRC message. The UE assistance information may indicate that PUSCH repetition is enabled. The UE assistance information may also indicate that PDCP duplication is disabled. Whether PUSCH repetition is enabled or disabled may be indicated with a 1 or a 0. Whether PDCP duplication is enabled or disabled may be indicated with a 1 or a 0. When CA and/or DC is configured, UE 210 may determine whether 3GPP Release 16 (R16) is supported by UE 210 and/or base station 222 (block 1360). UE 210 may determine whether R16 is supported based on system information stored locally by UE 210 and/or based on system information (e.g., a SIB) received from base station 222.

Referring to FIG. 14, when R16 is not supported, UE 210 may generate and communicate UE assistance information to base station 222 (block 1410). UE 210 may also enable (or forego disabling) PUSCH repetition and disable (or forego enabling) PDCP duplication. In some implementations, the UE assistance information may include a coverage assistance value (e.g., a 1-bit value), a field, an IE, or an RRC message. The UE assistance information may indicate that PUSCH repetition is enabled. The UE assistance information may also indicate that PDCP duplication is disabled. Whether PUSCH repetition is enabled or disabled may be indicated with a 1 or a 0. Whether PDCP duplication is enabled or disabled may be indicated with a 1 or a 0.

When R16 is supported, UE 210 may evaluate measurements of signals from neighboring cells (block 1420). UE 210 may determine an EWMA for measured signals from neighboring cells and may evaluate the measured signals based on the EWMA. This may include determining whether a detected slope degree or percentage of the EWMA is higher than a corresponding threshold (also referred to herein as an EWMA threshold, which may be a configurable threshold).

When a weighted average of neighboring cell measurements is below the threshold, UE 210 may proceed by generating and communicating UE assistance information to base station 222 (block 1430). UE 210 may also enable (or forego disabling) PUSCH repetition and disable (or forego enabling) PDCP duplication. The UE assistance information may include a coverage assistance value (e.g., a 1-bit value), a field, an IE, or an RRC message. The UE assistance information may indicate that PUSCH repetition is enabled. The UE assistance information may also indicate that PDCP duplication is disabled. Whether PUSCH repetition is enabled or disabled may be indicated with a 1 or a 0. Whether PDCP duplication is enabled or disabled may be indicated with a 1 or a 0.

When the weighted average of neighboring cell measurements is below the threshold, UE 210 may procced by generating and communicating UE assistance information to indicate that PUSCH repetition is enabled and PDCP duplication is enabled (block 1440). UE 210 may also enable (or forego disabling) PUSCH repetition and enable (or forego disabling) PDCP duplication. The UE assistance information may include a coverage assistance value (e.g., a 1-bit value), a field, an IE, or an RRC message. The UE assistance information may indicate that PUSCH repetition is enabled. The UE assistance information may also indicate that PDCP duplication is disabled. Whether PUSCH repetition is enabled or disabled may be indicated with a 1 or a 0. Whether PDCP duplication is enabled or disabled may be indicated with a 1 or a 0.

Base station 222 may receive UE assistant information from UE 210. Base station may determine UE configuration information based on the UE assistance information. Base station 222 may communicate the UE configuration information to UE 210 (block 1450). The UE configuration information may include a CG and/or DG for a PUSCH. The UE configuration information may be consistent with an indication by UE 210 that PUSCH repetition and/or PDCP duplication are enabled/disabled. The UE configuration information may include RRC configuration information, RRC reconfiguration information, and/or DCI activation information.

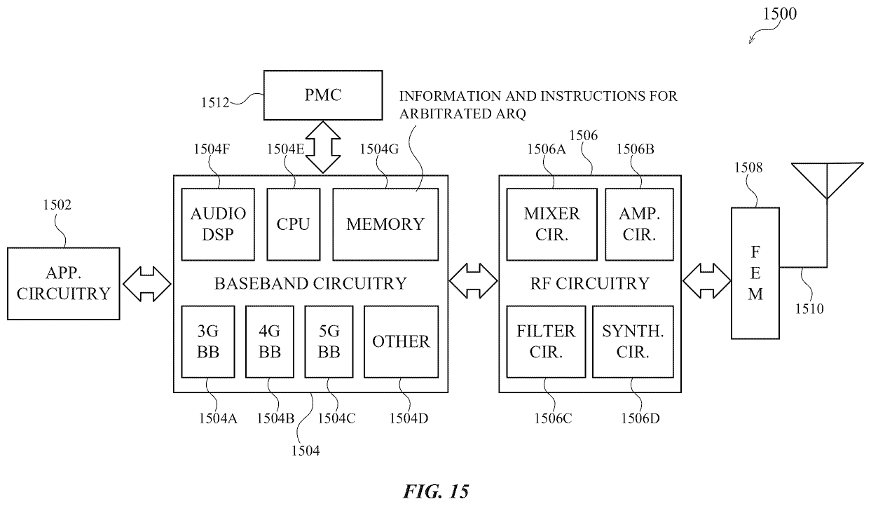

FIG. 15 is a diagram of an example of components of a device according to one or more implementations described herein. In some implementations, the device 1500 can include application circuitry 1502, baseband circuitry 1504, RF circuitry 1506, front-end module (FEM) circuitry 1508, one or more antennas 1510, and power management circuitry (PMC) 1512 coupled together at least as shown. The components of the illustrated device 1500 can be included in a UE or a RAN node. In some implementations, the device 1500 can include fewer elements (e.g., a RAN node may not utilize application circuitry 1502, and instead include a processor/controller to process IP data received from a CN or an Evolved Packet Core (EPC)). In some implementations, the device 1500 can include additional elements such as, for example, memory/storage, display, camera, sensor (including one or more temperature sensors, such as a single temperature sensor, a plurality of temperature sensors at different locations in device 1500, etc.), or input/output (I/O) interface. In other implementations, the components described below can be included in more than one device (e.g., said circuitries can be separately included in more than one device for Cloud-RAN (C-RAN) implementations).

The application circuitry 1502 can include one or more application processors. For example, the application circuitry 1502 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1500. In some implementations, processors of application circuitry 1502 can process IP data packets received from an EPC.

The baseband circuitry 1504 can include circuitry such as, but not limited to, one or more single-core or multi-core processors. The baseband circuitry 1504 can include one or more baseband processors or control logic to process baseband signals received from a receive signal path of the RF circuitry 1506 and to generate baseband signals for a transmit signal path of the RF circuitry 1506. Baseband circuitry 1504 can interface with the application circuitry 1502 for generation and processing of the baseband signals and for controlling operations of the RF circuitry 1506. For example, in some implementations, the baseband circuitry 1504 can include a 3G baseband processor 1504A, a 4G baseband processor 1504B, a 5G baseband processor 1504C, or other baseband processor(s) 1504D for other existing generations, generations in development or to be developed in the future (e.g., 5G, 6G, etc.). The baseband circuitry 1504 (e.g., one or more of baseband processors 1504A-D) can handle various radio control functions that enable communication with one or more radio networks via the RF circuitry 1506. In other implementations, some or all of the functionality of baseband processors 1504A-D can be included in modules stored in the memory 1504G and executed via a Central Processing Unit (CPU) 1504E. The radio control functions can include, but are not limited to, signal modulation/demodulation, encoding/decoding, radio frequency shifting, etc. In some implementations, modulation/demodulation circuitry of the baseband circuitry 1504 can include Fast-Fourier Transform (FFT), precoding, or constellation mapping/de-mapping functionality. In some implementations, encoding/decoding circuitry of the baseband circuitry 1504 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1504G may receive and/or store information and instructions for enabling arbitrated ARQ. This may include implementing a transmission repeating technique, such as a PDCP duplication and/or PUSCH repetition, which may be implemented based on one or more factors or conditions. Examples of such factors or conditions may include different available Tx chains and associated radio conditions; UE capabilities, and flow control latency. Additional examples may include a latency enabler supported in CA/DC configurations and/or an exponentially weighted moving average of neighbor cell measurements. The transmission repeating technique may include UE 210 implementing PDCP duplication only, PUSCH repetition only, both PDCP duplication and PUSCH repetition, or neither of PDCP duplication and PUSCH repetition.

In some implementations, the baseband circuitry 1504 can include one or more audio digital signal processor(s) (DSP) 1504F. The audio DSPs 1504F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1504 and the application circuitry 1502 can be implemented together such as, for example, on a system on a chip (SOC).

In some implementations, the baseband circuitry 1504 can provide for communication compatible with one or more radio technologies. For example, in some implementations, the baseband circuitry 1504 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1504 is configured to support radio communications of more than one wireless protocol can be referred to as multi-mode baseband circuitry.

RF circuitry 1506 can enable communication with wireless networks using modulated electromagnetic radiation through a non-solid medium. In various implementations, the RF circuitry 1506 can include switches, filters, amplifiers, etc. to facilitate the communication with the wireless network. RF circuitry 1506 can include a receive signal path which can include circuitry to down-convert RF signals received from the FEM circuitry 1508 and provide baseband signals to the baseband circuitry 1504. RF circuitry 1506 can also include a transmit signal path which can include circuitry to up-convert baseband signals provided by the baseband circuitry 1504 and provide RF output signals to the FEM circuitry 1508 for transmission.

In some implementations, the receive signal path of the RF circuitry 1506 can include mixer circuitry 1506A, amplifier circuitry 1506B and filter circuitry 1506C. In some implementations, the transmit signal path of the RF circuitry 1506 can include filter circuitry 1506C and mixer circuitry 1506A. RF circuitry 1506 can also include synthesizer circuitry 1506D for synthesizing a frequency for use by the mixer circuitry 1506A of the receive signal path and the transmit signal path. In some implementations, the mixer circuitry 1506A of the receive signal path can be configured to down-convert RF signals received from the FEM circuitry 1508 based on the synthesized frequency provided by synthesizer circuitry 1506D. The amplifier circuitry 1506B can be configured to amplify the down-converted signals and the filter circuitry 1506C can be a low-pass filter (LPF) or band-pass filter (BPF) configured to remove unwanted signals from the down-converted signals to generate output baseband signals. Output baseband signals can be provided to the baseband circuitry 1504 for further processing. In some implementations, the output baseband signals can be zero-frequency baseband signals, although this is not a requirement. In some implementations, mixer circuitry 1506A of the receive signal path can comprise passive mixers, although the scope of the implementations is not limited in this respect.

In some implementations, the mixer circuitry 1506A of the transmit signal path can be configured to up-convert input baseband signals based on the synthesized frequency provided by the synthesizer circuitry 1506D to generate RF output signals for the FEM circuitry 1508. The baseband signals can be provided by the baseband circuitry 1504 and can be filtered by filter circuitry 1506C.

In some implementations, the mixer circuitry 1506A of the receive signal path and the mixer circuitry 1506A of the transmit signal path can include two or more mixers and can be arranged for quadrature down conversion and up conversion, respectively. In some implementations, the mixer circuitry 1506A of the receive signal path and the mixer circuitry 1506A of the transmit signal path can include two or more mixers and can be arranged for image rejection (e.g., Hartley image rejection). In some implementations, the mixer circuitry 1506A of the receive signal path and the mixer circuitry 1406A can be arranged for direct down conversion and direct up conversion, respectively. In some implementations, the mixer circuitry 1506A of the receive signal path and the mixer circuitry 1506A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1506 can include analog-to-digital converter (ADC) and digital-to-analog converter (DAC) circuitry and the baseband circuitry 1504 can include a digital baseband interface to communicate with the RF circuitry 1506.

In some dual-mode implementations, a separate radio IC circuitry can be provided for processing signals for each spectrum, although the scope of the implementations is not limited in this respect.

In some implementations, the synthesizer circuitry 1506D can be a fractional-N synthesizer or a fractional N/N+1 synthesizer, although the scope of the implementations is not limited in this respect as other types of frequency synthesizers can be suitable. For example, synthesizer circuitry 1506D can be a delta-sigma synthesizer, a frequency multiplier, or a synthesizer comprising a phase-locked loop with a frequency divider.

The synthesizer circuitry 1506D can be configured to synthesize an output frequency for use by the mixer circuitry 1506A of the RF circuitry 1506 based on a frequency input and a divider control input. In some implementations, the synthesizer circuitry 1506D can be a fractional N/N+1 synthesizer.

In some implementations, frequency input can be provided by a voltage-controlled oscillator (VCO), although that is not a requirement. Divider control input can be provided by either the baseband circuitry 1504 or the applications circuitry 1502 depending on the desired output frequency. In some implementations, a divider control input (e.g., N) can be determined from a look-up table based on a channel indicated by the applications circuitry 1502.

Synthesizer circuitry 1506D of the RF circuitry 1506 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1506D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1506 can include an IQ/polar converter.

FEM circuitry 1508 can include a receive signal path which can include circuitry configured to operate on RF signals received from one or more antennas 1510, amplify the received signals and provide the amplified versions of the received signals to the RF circuitry 1506 for further processing. FEM circuitry 1508 can also include a transmit signal path which can include circuitry configured to amplify signals for transmission provided by the RF circuitry 1506 for transmission by one or more of the one or more antennas 1510. In various implementations, the amplification through the transmit or receive signal paths can be done solely in the RF circuitry 1506, solely in the FEM circuitry 1508, or in both the RF circuitry 1506 and the FEM circuitry 1508.

In some implementations, the FEM circuitry 1508 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1506). The transmit signal path of the FEM circuitry 1508 can include a power amplifier (PA) to amplify input RF signals (e.g., provided by RF circuitry 1506), and one or more filters to generate RF signals for subsequent transmission (e.g., by one or more of the one or more antennas 1510).

In some implementations, the PMC 1512 can manage power provided to the baseband circuitry 1504. In particular, the PMC 1512 can control power-source selection, voltage scaling, battery charging, or DC-to-DC conversion. The PMC 1512 can often be included when the device 1500 is capable of being powered by a battery, for example, when the device is included in a UE. The PMC 1512 can increase the power conversion efficiency while providing desirable implementation size and heat dissipation characteristics.

While FIG. 15 shows the PMC 1512 coupled only with the baseband circuitry 1504. However, in other implementations, the PMC 1512 may be additionally or alternatively coupled with, and perform similar power management operations for, other components such as, but not limited to, application circuitry 1502, RF circuitry 1506, or FEM circuitry 1508.

In some implementations, the PMC 1512 can control, or otherwise be part of, various power saving mechanisms of the device 1500. For example, if the device 1500 is in an RRC_Connected state, where it is still connected to the RAN node as it expects to receive traffic shortly, then it can enter a state known as Discontinuous Reception Mode (DRX) after a period of inactivity. During this state, the device 1500 can power down for brief intervals of time and thus save power.

If there is no data traffic activity for an extended period of time, then the device 1500 can transition off to an RRC_Idle state, where it disconnects from the network and does not perform operations such as channel quality feedback, handover, etc. The device 1500 goes into a very low power state and it performs paging where again it periodically wakes up to listen to the network and then powers down again. The device 1500 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1502 and processors of the baseband circuitry 1504 can be used to execute elements of one or more instances of a protocol stack. For example, processors of the baseband circuitry 1504, alone or in combination, can be used execute Layer 3, Layer 2, or Layer 1 functionality, while processors of the baseband circuitry 1504 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a PDCP layer, described in further detail below. As referred to herein, Layer 1 can comprise a physical (PHY) layer of a UE/RAN node, described in further detail below.

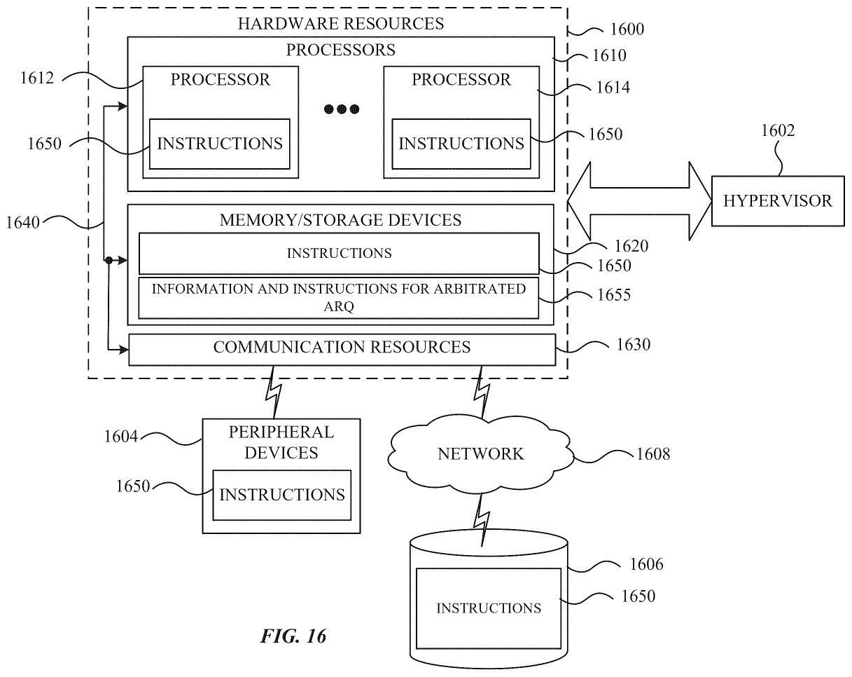

FIG. 16 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 16 shows a diagrammatic representation of hardware resources 1600 including one or more processors (or processor cores) 1610, one or more memory/storage devices 1620, and one or more communication resources 1630, each of which may be communicatively coupled via a bus 1640. For implementations where node virtualization (e.g., NFV) is utilized, a hypervisor may be executed to provide an execution environment for one or more network slices/sub-slices to utilize the hardware resources 1600.

The processors 1610 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1612 and a processor 1614.

The memory/storage devices 1620 may include main memory, disk storage, or any suitable combination thereof. The memory/storage devices 1620 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1620 may receive and/or store information and instructions 1655 for enabling arbitrated ARQ. This may include implementing a transmission repeating technique, such as a PDCP duplication and/or PUSCH repetition, which may be implemented based on one or more factors or conditions. Examples of such factors or conditions may include different available Tx chains and associated radio conditions; UE capabilities, and flow control latency. Additional examples may include a latency enabler supported in CA/DC configurations and/or an exponentially weighted moving average of neighbor cell measurements. The transmission repeating technique may include UE 210 implementing PDCP duplication only, PUSCH repetition only, both PDCP duplication and PUSCH repetition, or neither of PDCP duplication and PUSCH repetition.

The communication resources 1630 may include interconnection or network interface components or other suitable devices to communicate with one or more peripheral devices 1604 or one or more databases 1606 via a network 1608. For example, the communication resources 1630 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1650 may comprise software, a program, an application, an applet, an app, or other executable code for causing at least any of the processors 1610 to perform any one or more of the methodologies discussed herein. The instructions 1650 may reside, completely or partially, within at least one of the processors 1610 (e.g., within the processor's cache memory), the memory/storage devices 1620, or any suitable combination thereof. Furthermore, any portion of the instructions 1650 may be transferred to the hardware resources 1600 from any combination of the peripheral devices 1604 or the databases 1606. Accordingly, the memory of processors 1610, the memory/storage devices 1620, the peripheral devices 1604, and the databases 1606 are examples of computer-readable and machine-readable media.

Examples and/or implementations herein may include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a user device (UE) may comprise: a memory; and one or more processors configured to, when executing instructions stored in the memory, cause the UE to: determine one or more conditions associated with at least one serving cell of the UE; and implement, based on the one or more conditions, at least one transmission repetition technique for uplink (UL) communications to the at least one serving cell.

In example 2, which may also include one or more of the examples described herein, the at least one transmission repetition technique comprises packet data convergence protocol (PDCP) duplication or physical uplink shared channel (PUSCH) repetition.

In example 3, which may also include one or more of the examples described herein, the at least one transmission repetition technique comprises PDCP duplication and PUSCH repetition.

In example 4, which may also include one or more of the examples described herein, the at least one transmission repetition technique comprises disabling packet data convergence protocol (PDCP) duplication or physical uplink shared channel (PUSCH) repetition.

In example 5, which may also include one or more of the examples described herein, the UE may communicate, to the at least one service cell, UE assistance information indicating the at least one transmission repetition technique.

In example 6, which may also include one or more of the examples described herein, the UE may receive, from the at least one serving cell and in response to the UE assistance information, control information configured to enable the UE to implement the at least one transmission repetition technique indicated in the UE assistance information.

In example 7, which may also include one or more of the examples described herein, the one or more conditions comprises a reference signal received power (RSRP) and a reference signal received quality (RSRQ) of the serving cell.

In example 8, which may also include one or more of the examples described herein, the one or more conditions comprises a latency associated with a traffic flow between the UE and the service cell.

In example 9, which may also include one or more of the examples described herein, the one or more conditions comprises the UE communicating voice-over NR traffic to a base station of the serving cell.

In example 10, which may also include one or more of the examples described herein, the one or more conditions comprises the UE using carrier aggregation (CA) or dual connectivity (DC) to communicate with the serving cell.

In example 11, which may also include one or more of the examples described herein, the one or more conditions comprises a latency of an Xn communication interface exceeding a latency threshold.

In example 12, which may also include one or more of the examples described herein, the one or more conditions comprises a low latency associated with only a primary cell (PCell) of the UE.

In example 13, which may also include one or more of the examples described herein, the one or more conditions comprises an exponentially weighted moving average (EWMA) associated with at least one measurement of at least one neighboring cell.

In example 14, which may also include one or more of the examples described herein, the one or more conditions comprises a strength and quality of a signal from a master cell group (MCG) and a strength and quality of a signal from a secondary cell group (SCG).

In example 15, which may also include one or more of the examples described herein, the one or more conditions comprise the UE supporting one or more 3rd Generation Partnership Program (3GPP) Releases.

In example 16, which may also include one or more of the examples described herein, a base station may comprise: a memory; and one or more processors configured to, when executing instructions stored in the memory, cause the base station to: receive, from a user equipment (UE), an indication of at least one transmission repetition technique for uplink (UL) communications from the UE; determine, based on the at least one transmission repetition technique, configuration information to enable UE to use the at least one transmission repetition technique for UL communications; and communicate, to the UE, the configuration information.

In example 17, which may also include one or more of the examples described herein, the indication is received as UE assistance information.

In example 18, which may also include one or more of the examples described herein, the control information comprises radio resource control (RRC) configuration information or downlink (DL) control information.

In example 19, which may also include one or more of the examples described herein, the at least one transmission repetition technique comprises packet data convergence protocol (PDCP) duplication or physical uplink shared channel (PUSCH) repetition.

In example 20, which may also include one or more of the examples described herein, the at least one transmission repetition technique comprises PDCP duplication and PUSCH repetition.

In example 21, which may also include one or more of the examples described herein, a method, performed by a user equipment (UE), may comprise: determining one or more conditions associated with at least one serving cell of the UE; and implementing, based on the one or more conditions, at least one transmission repetition technique for uplink (UL) communications to the at least one serving cell.

In example 22, which may also include one or more of the examples described herein, a computer-readable medium, comprising one or more instructions that when executed by one or more processors, cause a user equipment (UE) to: determine one or more conditions associated with at least one serving cell of the UE; and implement, based on the one or more conditions, at least one transmission repetition technique for uplink (UL) communications to the at least one serving cell.

In example 23, which may also include one or more of the examples described herein, a method, performed by a base station, may comprise receiving, from a user equipment (UE), an indication of at least one transmission repetition technique for uplink (UL) communications from the UE; determining, based on the at least one transmission repetition technique, configuration information to enable UE to use the at least one transmission repetition technique for UL communications; and communicating, to the UE, the configuration information.

In example 24, which may also include one or more of the examples described herein, a computer-readable medium, may comprise one or more instructions that when executed by one or more processors, cause a base station to: receive, from a user equipment (UE), an indication of at least one transmission repetition technique for uplink (UL) communications from the UE; determine, based on the at least one transmission repetition technique, configuration information to enable UE to use the at least one transmission repetition technique for UL communications; and communicate, to the UE, the configuration information.

The examples discussed above also extend to method, computer-readable medium, and means-plus-function claims and implementations, an of which may include one or more of the features or operations of any one or combination of the examples mentioned above.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user device (UE), comprising:
a memory; and
one or more processors configured to, when executing instructions stored in the memory, cause the UE to:
determine one or more conditions associated with at least one serving cell of the UE; and
implement, based on the one or more conditions, at least one transmission repetition technique for uplink (UL) communications to the at least one serving cell.

2. The UE of claim 1, wherein the at least one transmission repetition technique comprises packet data convergence protocol (PDCP) duplication or physical uplink shared channel (PUSCH) repetition.

3. The UE of claim 1, wherein the at least one transmission repetition technique comprises PDCP duplication and PUSCH repetition.

4. The UE of claim 1, wherein the at least one transmission repetition technique comprises disabling packet data convergence protocol (PDCP) duplication or physical uplink shared channel (PUSCH) repetition.

5. The UE of claim 1, wherein the UE is to:
communicate, to the at least one service cell, UE assistance information indicating the at least one transmission repetition technique.

6. The UE of claim 5, wherein the UE is to:
receive, from the at least one serving cell and in response to the UE assistance information, control information configured to enable the UE to implement the at least one transmission repetition technique indicated in the UE assistance information.

7. The UE of claim 1, wherein the one or more conditions comprises a reference signal received power (RSRP) and a reference signal received quality (RSRQ) of the serving cell.

8. The UE of claim 1, wherein the one or more conditions comprises a latency associated with a traffic flow between the UE and the service cell.

9. The UE of claim 1, wherein the one or more conditions comprises the UE communicating voice-over NR traffic to a base station of the serving cell.

10. The UE of claim 1, wherein the one or more conditions comprises the UE using carrier aggregation (CA) or dual connectivity (DC) to communicate with the serving cell.

11. The UE of claim 1, wherein the one or more conditions comprises a latency of an Xn communication interface exceeding a latency threshold.

12. The UE of claim 1, wherein the one or more conditions comprises a low latency associated with only a primary cell (PCell) of the UE.

13. The UE of claim 1, wherein the one or more conditions comprises an exponentially weighted moving average (EWMA) associated with at least one measurement of at least one neighboring cell.

14. The UE of claim 1, wherein the one or more conditions comprises a strength and quality of a signal from a master cell group (MCG) and a strength and quality of a signal from a secondary cell group (SCG).

15. The UE of claim 1, wherein the one or more conditions comprise the UE supporting one or more 3rd Generation Partnership Program (3GPP) Releases.

16. A base station, comprising:
a memory; and
one or more processors configured to, when executing instructions stored in the memory, cause the base station to:
receive, from a user equipment (UE), an indication of at least one transmission repetition technique for uplink (UL) communications from the UE;
determine, based on the at least one transmission repetition technique, configuration information to enable UE to use the at least one transmission repetition technique for UL communications; and
communicate, to the UE, the configuration information.

17. The base station of claim 16, wherein the indication is received as UE assistance information.

18. The base station of claim 16, wherein the control information comprises radio resource control (RRC) configuration information or downlink (DL) control information.

19. The base station of claim 16, wherein the at least one transmission repetition technique comprises packet data convergence protocol (PDCP) duplication or physical uplink shared channel (PUSCH) repetition.

20. The base station of claim 16, wherein the at least one transmission repetition technique comprises PDCP duplication and PUSCH repetition.

21. A method, performed by a user equipment (UE), comprising:
determining one or more conditions associated with at least one serving cell of the UE; and
implementing, based on the one or more conditions, at least one transmission repetition technique for uplink (UL) communications to the at least one serving cell.

22. A baseband processor, comprising:
a memory; and
one or more processors configured to, when executing instructions stored in the memory, cause the one or more processors to:
determine one or more conditions associated with at least one serving cell of a user equipment (UE); and
implement, based on the one or more conditions, at least one transmission repetition technique for uplink (UL) communications to the at least one serving cell.

23. A method, performed by a base station, the method comprising:
receiving, from a user equipment (UE), an indication of at least one transmission repetition technique for uplink (UL) communications from the UE;
determining, based on the at least one transmission repetition technique, configuration information to enable UE to use the at least one transmission repetition technique for UL communications; and
communicating, to the UE, the configuration information.

24. A computer-readable medium, comprising one or more instructions that when executed by one or more processors, cause a base station to:
receive, from a user equipment (UE), an indication of at least one transmission repetition technique for uplink (UL) communications from the UE;
determine, based on the at least one transmission repetition technique, configuration information to enable UE to use the at least one transmission repetition technique for UL communications; and
communicate, to the UE, the configuration information.
